(19) United States
(12) Patent Application Publication
(10) Pub. No.: US 2008/0281711 A1
(43) Pub. Date: Nov. 13, 2008

(54) System and method for displaying advertisements according to business and consumer relevance

(76) Inventors: Thomas L. BRIDGES, Melbourne Beach, FL (US); Jaimie HENDERSON, Stanford, CA (US); David A. BOLEY, Indian Harbor Beach, FL (US); David Alan HOELLER, Tustin, CA (US); Anthony P. GALLUSCIO, Indialantic, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/152,025

(22) Filed: May 12, 2008

Related U.S. Application Data
(60) Provisional application No. 60/928,853, filed on May 11, 2007.

(51) Int. Cl. G06Q 30/00

(52) U.S. Cl. 705/14

(57) ABSTRACT

A system and method for the selection and delivery of at least one targeted advertisement over a network, wherein the targeted advertisement conforms to the preferences and criteria specified by each respective user and each respective advertiser. The targeted advertisement selections may be prioritized via correlation of a wide variety of user information and advertiser information. Such a system and method provide for delivery of highly targeted advertisements that ensures a retailer that advertisement marketing is reaching their desired demographic audience and, likewise, exposes each respective end user to highly relevant product and service advertisements. The present invention further increases network efficiency by performing advertisement selection and formatting only once at user login to eliminate continual fetching and formatting of new advertisements during the session. The system or method may employ a map of advertisements that is generated for the user a single time at login.

### CROSS REFERENCE TO RELATED APPLICATIONS

This application claims the benefit of provisional patent application Ser. No. 60/928,853, filed with the USPTO on May 5, 2007, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to the advertising of goods and services, more specifically, the present invention relates to selecting and displaying targeted advertisements over a network such as the Internet.

2. Background Art

Online services today offer a variety of functionality to their users. Users may access news, weather, financial, sports, and entertainment services, participate in and retrieve information from online discussion groups, and send and receive email. A user of an online service typically accesses the service using specialized communication software that establishes and manages a connection from the user's computer to the online service provider's host computers or servers and facilitates the user's interactions with the service.

In addition to managing the connection, there is provided software to display pages or screens relating to retrieved content according to views or presentations specific to the online service. This software may be integrated with the client application. The functionality of the content and the user interface (i.e., icons, dialog boxes, menus, etc.) for interacting with the content are typically dictated by various standards.

Interactions between the user's computer and the online service are facilitated by a variety of software protocols (i.e., communication conventions, rules and structures), including application level protocols, for managing the transfer of data across the network and to the client application on the user's computer. A protocol may be proprietary or exclusive to an online service such that only client software from the online service provider may be used to communicate with the server software. For example, an online service provider that supports electronic mail, discussion groups, chat groups, news services, etc. may define and use specific protocols for each type of service so that appropriate information is exchanged between the participants (i.e., clients and servers). Each application-specific protocol may be based on a common, underlying protocol.

The Internet and World Wide Web (“Web”), comprised of a vast array of international computer networks, may provide online service users with considerable information resources and other content. Typically, this content is accessed using a web browser, such as Microsoft Internet Explorer or Netscape Navigator, capable of understanding the HyperText Markup Language (HTML) used to create the documents found on the Web and the HyperText Transfer Protocol (HTTP) used to navigate the Web. Email and Usenet discussion groups are typically accessed through companion software to the browser. Although web browsers typically have varying levels of functionality or sophistication, retrieved content is displayed in content pages according to views or presentations specific to the web document currently presented by the web browser. Typically, the views and presentations are different than those provided by the communication software from the online service provider because the web browser is, in fact, a separate client application displaying web documents containing presentation directives.

When using a browser, the browser issues HTTP messages to request web pages. A requested web page is typically identified using its URL—uniform resource locator. The URL is a reference (or address) to a resource available on a TCP/IP network such as the Internet. A URL is composed of a character string, and may have a number of parts. These parts include a top level domain name, second level domain name, directory name, and file name. URLs may identify a file located on a web server. URLs may also point to other resources on the network such as database queries and command output. The determination and use of URLs is well known in the art and is not discussed further herein.

In some portions of this disclosure, the term “resource locator” is used. The term is defined as a string or code which uniquely identifies a resource on a network. Thus, the URL is a species of resource locator.

There are a number of types of online service providers (OSPs). Online services may serve the general public or may serve a limited class of individuals. Some public OSPs utilize proprietary networks; America Online and @Home are examples. Other public OSPs use the public networks, and most Internet Service Providers (ISPs) are an example. OSPs often provide Internet access. Internet access is the primary service provided by some OSPs, most notably ISPs.

Users typically connect to an OSP using a computer with a communications device such as an analog modem, an Ethernet adapter, DSL adapter or cable modem. Such connections may be analog or digital, dial-up or constantly-connected. Subscribers typically pay a fee for their subscriptions to OSPs. These fees typically are in the form of a sign-up fee, plus online charges which are fixed (i.e., unlimited monthly access for a fixed fee) or based upon the amount of time the user is connected to the online service. The fees generally increase with bandwidth.

Some online service providers have derived revenue by displaying advertisements for third parties (hereinafter, “advertisements”) to users. For example, when a user accesses a web page on the Web, an advertisement may be displayed to the user as part of the web page. Advertisements are also shown to users of some proprietary online services. Typically in such systems, each user accessing a certain screen or site is shown the same advertisement. Sophisticated systems have the capability to change the advertisement after a certain period of time.

Some attempts have been made to provide advertising-supported online services, including Internet access, on a free or heavily discounted basis. Typically, these online services required the user to use a special client application for connecting to the online service. The client application typically causes an advertising window to be displayed on the user's display. This advertising window remains visible and on top of other windows throughout the entire online session. The client application receives advertisements one at a time from the online service provider, and the client application displays the advertisements in the advertising window. It is unknown to the inventors, however, whether the transmission of advertisements from the online service provider to the client application is initiated by the online service provider or the client application, how the online service determines which advertisements to send to the users, and whether such typical client applications do anything more than open the communications link with the online service and display advertisements.

In one advertising based Internet service called Bigger.net, the client application periodically requested new advertisements from an ad server. A host computer monitored the time between such requests and terminated the connection if a preset period of time was exceeded. Bigger.net also had the ability to monitor network activity, though it is unclear how this was done.

Other advertising-supported online services have included: CyberFreeway, which used a client application developed by HyperNet, Inc. of Tokyo, Japan; Juno Online, which provided free email; Tritium and Freewwweb.

Advertisers find it desirable to target advertisements to relevant potential customers. For example, an advertiser of stockings would prefer to target women rather than men with its advertising. A Boston restaurant would prefer to target residents of Boston and business travelers rather than children living in San Francisco. Moreover, advertisers prefer to pay for advertising based upon the number of relevant consumers who are actually exposed to the advertisement. For typical online systems and networks, including the Web, it is often difficult for an advertiser to precisely determine whether its advertisements were actually viewed by a user and for how long, and whether the advertisement induced a response. Accordingly, there exists a need for a targeted advertisement system that also can provide information as to the characteristics of those who were exposed to each advertisement, for how long the user was exposed, and at what times.

It is believed that the prior art advertising-supported online services did not have the ability to target advertisements. Furthermore, their client applications are believed to have been limited in capabilities.

### BRIEF SUMMARY OF THE INVENTION

In accordance with the scope of the present invention, a system for delivering at least one targeted advertisement from at least one selected advertiser to a user, the system comprising a communication element for delivering the at least one targeted advertisement to the user, a content provider node for providing the user with access to a network via the communication element, a central database for electronically storing user information and at least one advertiser's information, a selection node for selecting the at least one selected advertiser based on the user information and the at least one advertiser's information, an advertisement database for electronically storing advertisement data linked to the at least one selected advertiser; and an advertisement node for selecting the advertisement data on the advertisement database linked to the at least one selected advertiser, wherein the at least one targeted advertisement from the at least one selected advertiser comprises at least one element of the advertisement data, wherein the at least one targeted advertisement from the at least one selected advertiser is delivered to the user via the communication element.

The scope of the present invention further encompasses a method for delivering at least one targeted advertisement from at least one selected advertiser to a user, the method comprising the steps of storing user information and at least one advertiser's information on a central database, receiving login information from the user over a network, wherein the login information corresponds to a user profile containing the user information, storing advertisement data linked to the at least one advertiser, selecting the at least one selected advertiser based on the user information and the at least one advertiser's information, storing advertisement data linked to the at least one selected advertiser, selecting the advertisement data on the advertisement database linked to the at least one selected advertiser, wherein the at least one targeted advertisement from the at least one selected advertiser comprises at least one element of the advertisement data; and delivering the at least one targeted advertisement from the at least one selected advertiser to the user via a communication element.

### BRIEF DESCRIPTION OF THE DRAWINGS

FIG. 1 depicts a block diagram of an embodiment of a targeted advertisement delivery system in accordance with the present invention.

FIG. 2 depicts a flow diagram of an embodiment of a targeted advertisement delivery method in accordance with the present invention

### DETAILED DESCRIPTION OF THE INVENTION

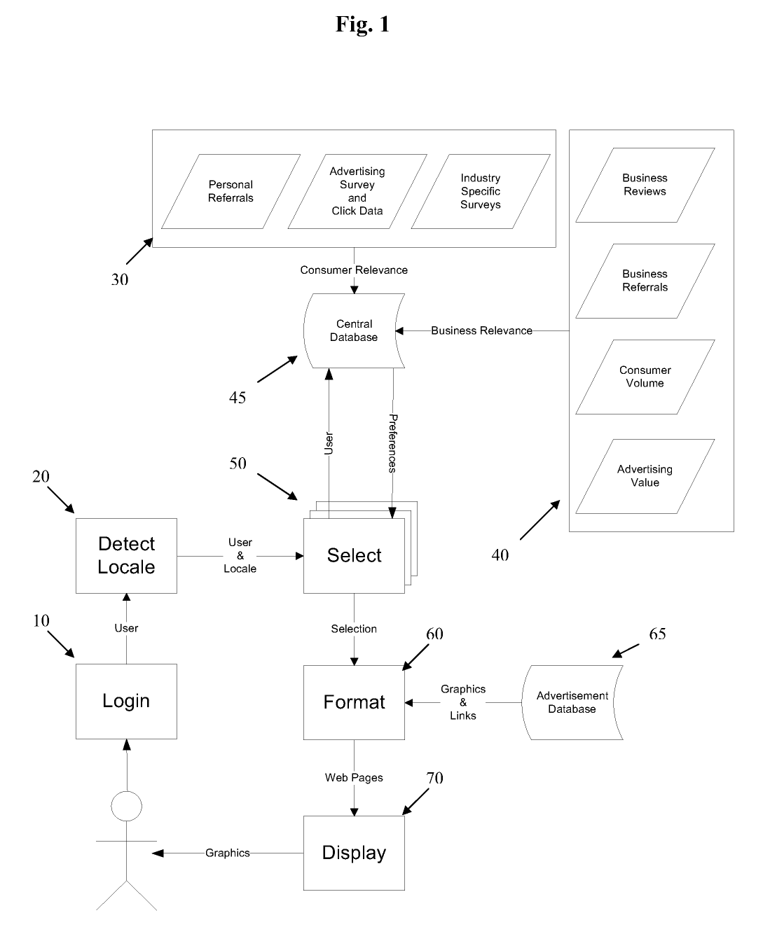

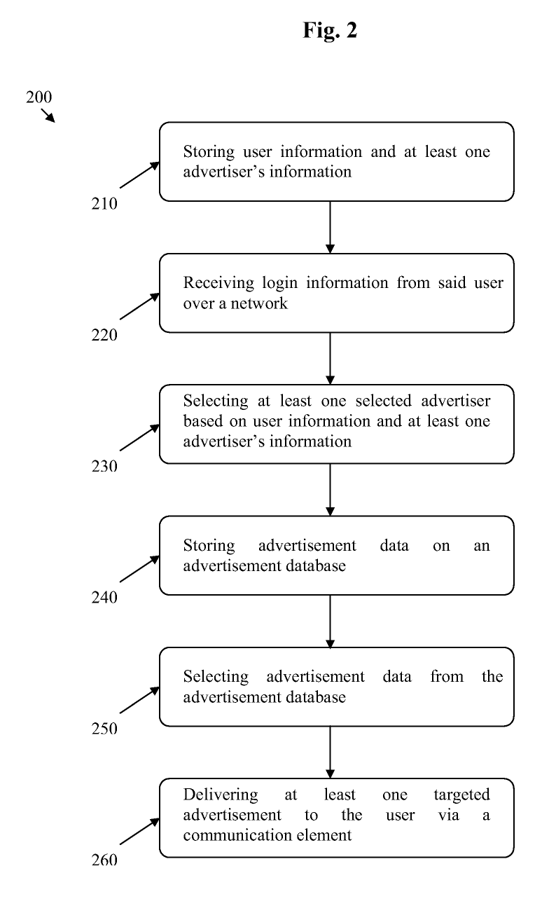

General embodiments of the present system and method for delivering at least one targeted advertisement of at least one advertiser to a user are depicted in FIGS. 1-2.

According to one embodiment of the invention, the present invention provides a beneficial method for targeting online advertisements that serves to maximize both an end consumer's product preferences as well as directing advertising campaigns to an advertiser's preferred demographic base.

The term “advertisement” as used throughout this description is intended to indicate both commercial advertisements and non-commercial messages of any sort including commercial advertisements and promotional messages, public service announcements, and the like. The messages may be visual, audio or audio-visual, using a variety of media including video, audio, text and/or graphics. For example, technologies currently exist which deliver information and advertising to computer users via the World Wide Web. The formats and contents of the messages communicated by the systems and methods of the present invention may include advertisements similar to the types of advertising displayed on web pages via the Internet (U.S. Pat. No. 6,009,410 to LeMole et al.; U.S. Pat. No. 6,009,409 to Adler et al.; U.S. Pat. No. 5,937,392 to Alberts; U.S. Pat. No. 5,959,623 to van Hoff et al.; U.S. Pat. No. 5,913,040 to Rakavy et al.; U.S. Pat. No. 5,933,811 to Angles, et al.; U.S. Pat. No. 5,948,061 to Merriman et al.).

The term “communication element” is intended to include any means of conveying the advertisement, announcement or message including visual, audio or combinations of both. Thus, the term “communication element” includes but is not limited to visual displays, speakers systems, a computer, a cell phone, a PDA, a television, a Web tablet, and the like. Delivery, display or communication of at least one targeted advertisement may occur in a variety of formats including but not limited to visual, audio, visual/audio, holographic 3D, animation, static images, and the like.

The present invention provides a system and method for more efficiently advertising products and services to target individuals using relevant information relating to the individuals and to at least one advertiser to select the at least one targeted advertisement. The term “targeted advertisement” is intended to include not only selecting the content of the advertisement (e.g., cigars vs. stockings), but may further include the style of the advertisement (e.g., ads geared for a young professional, college student or retired senior citizens). This allows the communication element to more effectively advertise the products and/or services being marketed.

Advertisers find it desirable to target advertisements to relevant potential consumers. An advertisement relating to a sale on golf clubs, for example, would be more effective if targeted at individuals who have an interest in golf products. As another example, an advertiser for stockings would prefer to target women rather than men. A Chicago-based restaurant would prefer to target residents of Chicago or frequent business travelers to the Chicago area as opposed to an individual who does not visit or live in Chicago. Previous advertising devices fail to precisely target advertisements to individuals likely to be impacted by the advertisements.

As depicted in FIG. 1, optimization of at least one targeted advertisement may be achieved using a combination of features. These features include the ability of the communication element 10 to display at least one targeted advertisement. Preferably, the at least one targeted advertisement and its constituent advertisement data are stored in an advertisement database 65. The system may further comprise one or more central databases 45 which may store the user information 30 and/or at least one advertiser's information 40. The present inventive system may communicate via cable, modem, wireless data modem, cellular technology or any other means of retrieving information from an external database known within the art. According to one embodiment, the communication element 10 may be linked via the Internet to a source for the consumer information 30, such as a central database 45, and to a source for the advertisement data, such as an advertisement database 65. Preferably, the communication element 10 may link to a variety of databases comprising a variety of advertisement and information sources. For example, the communication element 10 may be provided with an Internet link which allows the system to retrieve, access, and/or download user information 30, advertiser information 40, advertisement data, and other forms of information from the World Wide Web.

According to one embodiment, the system may select and display at least one targeted advertisement based on a correlation of advertiser information 40, such as geographic proximity of a user to at least one advertiser's retail location, with user information 30. Thus, the at least one targeted advertisement may be targeted based on an electronic profile of the user and the relevant information regarding the at least one advertiser. User information 30 may comprise at least one user characteristic including but not limited to gender, age, profession/occupation, income, nationality, educational background, religion, ethnicity, user ID, IP address, user cookie, user login code, user digital certificate, geographic location, time zone, country, domain name, telephone number, area code, physical address, zip code, Internet service provider, organization type, employer, industry type, company affiliation, number of employees, advertisements previously viewed, advertisements previously clicked, personal referrals, hobbies, interests, preferences, advertising survey responses, and industry specific survey responses, and the like. The information may be derived, for example, from user input during initial registration with a content provider network, online surveys, user requests for information made regarding certain products and services, and the like. Such a collection of user information 30 may be created from a variety of sources including the individual's on-line activities on the World Wide Web. These activities may include navigation choices, content preferences, shopping preferences, inputted data and information, etc. For example, on-line shopping environments today allow computer users to purchase products and/or services from a variety of merchants, vendors, manufacturers and service providers, each of which may maintain an online site for users to visit. Suitable consumer databases profiles could include databases such as those created by Abacus Direct Corp, which maintains a database of the names, addresses, demographics, and retail, catalog, and online purchase histories of 90 percent of the U.S. households. See also, U.S. Pat. No. 5,933,811 to Angles, et al.

The central database 45 may include a plurality of consumer profiles, each comprising an individual's user information 30. Data regarding the individual's preferences may be collected from a variety of sources as described above. See, for example, U.S. Pat. No. 6,014,638 to Burge et al. This raw data may be processed to create a preference profile of the specific individual's user information 30. General consumer profiles are well known in the art (see above referenced patents) and can include a wide variety of information relating to the individual consumers. Suitable consumer profile databases may include those employed in prior direct marketing efforts and/or online targeted advertising.

The system may further comprise an advertisement database 65 which may store a plurality of advertisement data thereon that may be thereafter delivered to the communication element 10. According to one embodiment, the advertisement data may be categorized by type of product and/or service being advertised. Preferably, a plurality of advertisements and their advertisement data components are stored in a medium such that selected advertisements can be efficiently retrieved and displayed to targeted identified users via the communication element 10. Advertisement data may be stored in a variety of forms including but not limited to targeted advertisements in their entirety and individual advertisement components. Depending on the available targeted advertisement space on the respective communication element 10, at least one targeted advertisement may be created from advertisement data and/or individual advertisement components. In this manner, at least one targeted advertisement may be constructed as needed in a piecemeal fashion and/or entire preconfigured advertisements may be available for immediate display on the communication element 10.

In use, a user may initially register with a content provider by providing user information 30 that may be stored within a central database 45 of the system. User registration and access may occur via a content provider node 20 that is preferably in communication with a network such as the Internet or a content provider network. In a preferred embodiment, a user is exposed to at least one targeted advertisement while logged into a specific content provider's network after having provided user information 30 during the registration process. Alternate embodiments may include but are not limited to content providers such as television and/or cable company networks wherein user information 30 may be provided during activation of the service and the cable network/system may thereafter target advertisements via a system or method within the scope of the present invention.

Preferably, the system performs a selection and/or ranking function to determine at least one optimal ad, or prioritized list of ads, to prospectively be display to the user. The at least optimal ad may be determined by correlating known user information 30 with at least one advertiser's information 40 stored within the system. The at least one advertiser's information 40 may be stored on the central database 45 of the system and may comprise at least one retailer characteristic including but not limited to business reviews, business referrals, consumer volume, advertising value, advertiser address, advertiser zip code, advertiser telephone number, area code, geographic location, time zone, country, organization type, industry type, company affiliations, number of employees, products provided, services provided, prospective product/service costs, brands of products provided, brands of services provided, sales promotions, sales incentives, discounts, customer loyalty program, preferred demographic information, and the like. Advertising fees paid by the at least one advertiser may also influence the correlation factor (i.e. strength of the match) between the user information 30 and at least one advertiser's information 40.

According to one embodiment, the at least one targeted advertisement may have more than one set of targeting parameters (e.g., women over 40 years of age and income greater than $100,000 or all individuals residing in a certain geographic area such as Manhattan). According to one embodiment, the at least one advertiser's information 40 may indicate the characteristics of the ad and facilitate matching with user information 30 linked to a consumer profile. For example, the system may employ an association processor for comparing preset targeting criteria of each targeted advertisement with a consumer profile comprising user information 30. The targeted advertisement and/or advertisement data may be stored in an advertisement database 65, while the consumer profiles and linked user information 30 may be stored in a central database 45. Preferably, each targeted advertisement may include such targeting parameters. For example, a particular advertisement may include the following targeting parameters: single men, ages 25-35, income greater than $50,000 and Washington, D.C. residence. The invention allows such a targeted advertisement to be targeted at individuals who meet the targeting parameters and may further prioritize such advertisements via correlation to stored user preferences and user information 30. Thus, the invention provides a means for associating advertisements with all or a subset of individuals falling within the advertisement's targeting parameters using the consumer profile and further prioritizing such advertisements in accordance with each respective user's references and information 30.

Preferably, the at least one targeted advertisement or advertisement data is stored in an advertisement database 65 and may be presorted or categorized in a manner (e.g. by targeting parameters) to facilitate retrieval of the targeted advertisements, once the advertiser selection process is completed.

In one embodiment, the system displays the most targeted (profitable) advertisements before less targeted ads, more preferably doing so in an economically maximizing way by sequencing from the most targeted (and, therefore, most profitable) to the least targeted advertisements. In another embodiment, the system may display the highest correlated targeted advertisement sequencing to the least correlated targeted advertisement. In this manner, a user would be exposed to targeted advertisements of greatest interest to them via a high correlation with the supplied user information 30.

According to one embodiment, the system may be connected to an advertisement database 65 or advertising repository server. See, U.S. Pat. No. 6,009,410 to LeMole et al. For example, the targeted advertisements may include advertisement data including but not limited to text, images (e.g. GIF or JPEG file format), graphics, links, banners, video, audio, and the like.

Preferably, the system may also be capable of automatically generating “non-targeted” ads when no identifying signal is received and/or when no user information 30 is available to correlate with the at least one advertiser's information 40.

In accordance with the present invention, the system is interactive in that after it displays an advertisement (targeted or nontargeted) on the communication element 10, the communication element 10 may also provide a means for allowing the user to provide feedback and/or request or seek additional information from the at least one advertiser. Since the advertisements are preferably targeted advertisements, the ability of the system to allow for such feedback could be advantageous since the users exposed to the targeted advertisements are intended to have an interest in the content of the advertisement and are likely to desire additional information. According to one embodiment, a targeted individual can interact with the targeted advertisement and such an interaction may take the user to a web page of the advertiser within the content provider's network, take to the user to a web page of the advertiser on the Internet, display an incentive or sale sponsored by the advertiser, and the like.

In accordance with a preferred embodiment, the method or system of the present invention is connected to a network such as the Internet. Advertisers may pay to have their targeted advertisements downloaded and/or delivered to the communication element 10 and/or pay an additional premium when a target advertisement is delivered to a targeted user or group of users. See, U.S. Pat. No. 5,946,646. According to another preferred embodiment, the number of targeted advertisements displayed may be recorded for billing purposes. Preferably, the system and/or communication element 10 may further include a “filter” which may filter out targeted advertisements which may be objectionable or unwanted by the targeted user.

Preferably, the invention includes a central database 45 for storing user information 30, an advertisement database 65 for storing advertisement data and/or targeted advertisements, and may comprise a means for certifying and/or recording that an advertisement has been displayed. See, U.S. Pat. No. 5,774,170 to Hite et al.; U.S. Pat. No. 6,002,393 to Hite et al.

In use as depicted in FIG. 1, an end consumer may first log into a network of a content provider, such as via registration with an online service. Consumer login via a communication element 10 may comprise the input of a username and password associated with an already established user account. Additionally, new users to the content provider network may be directed through steps to establish a new individual account, wherein user information 30 and/or preferences may be inputted and saved within their associated profile. Current users may further have the ability to refer friends to the content provider.

Upon login, the content provider may detect 20 the locale of the user via available geographic information from the inputted user's information 30 including but not limited to zip code, area code, and any available IP address information.

Geographic locale, user information 30, and/or relevant advertiser information 40 may be stored on and received from a central database 45 of the inventive system. Such information may be utilized in selecting 50 at least one advertiser that is highly relevant to both the interests of the user and the desired demographic of the at least one advertiser.

At least one targeted advertisement may be formatted 60 from advertisement data stored on an advertisement database 65, wherein the advertisement data may have been previously supplied by the at least one advertiser. Such a system and method is very efficient because selection 50 and formatting 60 of at least one targeted advertisement may be performed once at user login 10 and the prioritized targeted advertisements may then be used for the user's entire online session. The consumer's network experience is therefore improved and/or enhanced since the content provider's network or web site is no longer continually fetching and configuring new advertisements. In use, the system may get a map of targeted advertisements that is generated for the user a single time for that specific login session.

The formatted at least targeted advertisement may then be displayed 70 to and viewed by the targeted user on the communication element 10.

As depicted in FIG. 2, the scope of the present invention further includes a method 200 for delivering at least one targeted advertisement of at least one selected advertiser to a user. User information 30 and at least one advertiser's information 40 may be stored 210 on a central database 45. Such information may be provided by the user and/or advertiser upon registration with a content provider or gathered by any other means known within the art.

A profile comprising user information is useful in determining the type of targeted advertisement to display to a user. For example, if the profile indicates that user executed a search for “flowers”, an advertiser may desire to transmit a local flower shop advertisement to the user. A profile may also be utilized to specifically target users that utilize a competitor's goods or services. For example, if the profile contains knowledge that the user accesses a Pizza Hut web site, the content provider can include advertisements for Round Table Pizza or Dominos Pizza on the user's next web access, even if this access is to a totally unrelated site. Further, if the profile indicates that the user has inquired about Burger King, Jack in the Box, fast food, hamburgers, etc., the content provider can include advertisements for McDonalds or another competitor.

The network of the content provider may then receive 220 the login information from the user, wherein the login information corresponds to (i.e. is linked with) a user profile containing specific user information. At least one selected advertiser may then be selected 230 based on a correlation of the user information 30 and the at least one advertiser's information 40 stored on the central database 45. Such a correlation may take into account a weighted determination of the most relevant advertiser given the provided user information 30 and advertiser information 40. Geographic preference, user interests, advertiser products, and paid advertising fee may all be included in the multitude of factors used for prioritizing the relevance of available advertisers.

For efficient retrieval of targeted advertisements, advertisement data linked to respective advertisers may be stored 240 on an advertisement database 65. The advertisement data may comprise targeted advertisements in their entirety or components thereof.

Advertisement data on the advertisement database 65 linked to at least one selected advertiser may be selected 250 via a correlation of the user information 30 with the at least one advertiser's information 40. A targeted advertisement may comprise at least one element of advertisement data.

The at least one targeted advertisement of at least one selected advertiser may then be displayed 260 to the user via a communication element 10.

By evaluating user information 30 and advertiser information 40 as described, direct marketing advertisers and one-on-one advertisers may more accurately target specific individuals. Further, the content provider may benefit by selling advertising space and utilizing its collected user information 30, advertisers benefit by accurate targeting which results in an increased probability of a user click-through, and each user benefits by receiving targeted advertisements that the user may be particularly interested in. Additionally, if the user does not want his/her information released or collected, the user may enter into a contract with the content provider restricting the use, distribution, or collection of such information or utilize a content provider that does not maintain demographic databases or user information profiles.

The present inventive system is very efficient from a performance standpoint because selection and formatting results in an advertising web layout that is configured once upon login and is used for the entire login session. The system may get a map of advertisements that is generated for the user a single time for that login session. Because the web site is not continually fetching and configuring new advertisements, the user's experience is much improved over systems and methods of the prior art.

Such an inventive system and method ensure an advertiser that their targeted advertisements are being displayed to and viewed by their desired, targeted consumer audience. Likewise, the individual consumers are exposed to relevant products and services conforming to their stated preferences and interests. With such a targeted advertising system and method being utilized within an online service, the number of consumer viewings, identification of viewing consumers, and duration of advertisement exposures may be calculated from activity information that may be available on the content provider's central database.

Advertisers may be able to track the effectiveness of their targeted advertisement campaigns via monitoring the number of clicks from users that view the advertisements, and advertisers may even be able to monitor which clicks of interest escalate into actual sales generated by the targeted advertisements. When a user clicks on a targeted advertisement of the present invention, the user may be taken to the advertiser's home web site, to a web site displaying the business information of the specific advertiser, to a special incentive web page of the advertiser, or any other specific web page desired by the advertiser. Each user interaction with a targeted advertisement may at least be recorded as a “virtual visit” by an interested user that was initiated via the specific targeted advertisement.

Those of ordinary skill in the art will understand that while the communication element 10, the central database 45, and the advertisement database 65 are described as comprising physically distinct components on a network, that is not required. Still further, while the system and method may be described as being implemented on one computer platform performing all of the above described functions, it is readily understood by those of skill that any or all of these functions may be implemented on one or more different computers and further that these processes may be performed at different nodes on the network.

While the above description contains many specificities, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A system for delivering at least one targeted advertisement of at least one selected advertiser to a user, the system comprising:
a communication element for delivering said at least one targeted advertisement to said user;
a content provider node for providing said user with access to a network via said communication element;
a central database for electronically storing user information and at least one advertiser's information;
a selection node for selecting said at least one selected advertiser based on said user information and said at least one advertiser's information;
an advertisement database for electronically storing advertisement data linked to said at least one selected advertiser; and
an advertisement node for selecting said advertisement data on said advertisement database linked to said at least one selected advertiser, wherein said at least one targeted advertisement from said at least one selected advertiser comprises at least one element of said advertisement data;
wherein said at least one targeted advertisement of said at least one selected advertiser is delivered to said user via said communication element.

2. The system of claim 1, wherein said communication element is selected from the group consisting of a computer, a cell phone, a PDA, a television, and a Web tablet.

3. The system of claim 1, wherein said at least one selected advertiser is selected only once for each respective time said user accesses said network.

4. The system of claim 1, wherein said advertisement data on said advertisement database linked to said at least one selected advertiser is selected only once for each respective time said user accesses said network.

5. The system of claim 1, wherein said network comprises the Internet.

6. The method of claim 1, wherein said network comprises a content provider network.

7. The system of claim 1, wherein said user information comprises at least one user characteristic selected from the group consisting of gender, age, nationality, educational background, religion, ethnicity, user ID, IP address, user cookie, user login code, user digital certificate, geographic location, time zone, country, domain name, telephone number, area code, physical address, zip code, Internet service provider, organization type, employer, industry type, company affiliation, number of employees, advertisements previously viewed, advertisements previously clicked, personal referrals, hobbies, interests, preferences, advertising survey responses, and industry specific survey responses.

8. The system of claim 1, wherein said at least one advertiser's information comprises at least one advertiser characteristic selected from the group consisting of business reviews, business referrals, consumer volume, advertising value, advertiser address, advertiser zip code, advertiser telephone number, area code, geographic location, time zone, country, organization type, industry type, company affiliations, number of employees, products provided, services provided, prospective product/service costs, brands of products provided, brands of services provided, sales promotions, sales incentives, discounts, customer loyalty program, and preferred demographic information.

9. The system of claim 1, wherein said selection node correlates said user information with said at least one advertiser's information to prioritize said at least one selected advertiser.

10. The system of claim 1, wherein said advertisement data is selected from the group consisting of text, images, graphics, links, banners, sounds, and videos.

11. A method for delivering at least one targeted advertisement of at least one selected advertiser to a user, the method comprising the steps of:
storing user information and at least one advertiser's information on a central database;
receiving login information from said user over a network, wherein said login information corresponds to a user profile containing said user information;
selecting said at least one selected advertiser based on said user information and said at least one advertiser's information;
storing advertisement data linked to said at least one selected advertiser on an advertisement database;
selecting said advertisement data on said advertisement database linked to said at least one selected advertiser, wherein said at least one targeted advertisement from said at least one selected advertiser comprises at least one element of said advertisement data; and
delivering said at least one targeted advertisement of said at least one selected advertiser to said user via a communication element.

12. The method of claim 11, wherein said communication element is selected from the group consisting of a computer, a cell phone, a PDA, a television, and a Web tablet.

13. The method of claim 11, wherein said selection of said at least one selected advertiser is performed only once for each respective time said user accesses said network.

14. The method of claim 11, wherein said selection of said advertisement data on said advertisement database linked to said at least one selected advertiser is performed only once for each respective time said user accesses said network.

15. The method of claim 11, wherein said network comprises the Internet.

16. The method of claim 11, wherein said network comprises a content provider network.

17. The method of claim 11, wherein said user information comprises at least one user characteristic selected from the group consisting of gender, age, nationality, educational background, religion, ethnicity, user ID, IP address, user cookie, user login code, user digital certificate, geographic location, time zone, country, domain name, telephone number, area code, physical address, zip code, Internet service provider, organization type, employer, industry type, company affiliation, number of employees, advertisements previously viewed, advertisements previously clicked, personal referrals, hobbies, interests, preferences, advertising survey responses, and industry specific survey responses.

18. The method of claim 11, wherein said at least one advertiser's information comprises at least one advertiser characteristic selected from the group consisting of business reviews, business referrals, consumer volume, advertising value, advertiser address, advertiser zip code, advertiser telephone number, area code, geographic location, time zone, country, organization type, industry type, company affiliations, number of employees, products provided, services provided, prospective product/service costs, brands of products provided, brands of services provided, sales promotions, sales incentives, discounts, customer loyalty program, and preferred demographic information.

19. The method of claim 11, wherein said selection of said at least one selected advertiser correlates said user information with said at least one advertiser's information to prioritize said at least one selected advertiser.

20. The method of claim 11, wherein said advertisement data is selected from the group consisting of text, images, graphics, links, banners, sounds, and videos.
